(19) United States
(12) Patent Application Publication
(10) Pub. No.: US 2007/0085979 A1
(43) Pub. Date: Apr. 19, 2007

(54) Method and apparatus to manage light and reduce blur in microdisplay based light engines

(75) Inventor: Arthur Berman, San Jose, CA (US)

Correspondence Address: ARTHUR BERMAN, 5635 SNOWDON PLACE, CUPERTINO, CA, 95138, US

(73) Assignee: LightMaster Systems, Inc.

(21) Appl. No.: 11/251,319

(22) Filed: Oct. 14, 2005

(51) Int. Cl. G03B 21/14

(52) U.S. Cl. 353/97

(57) ABSTRACT

Light is managed through the use of a light shutter. The light shutter is, for example, a variable retarder in series with a reflective linear polarizer in a polarized light beam. A comet tail effect caused by transition latencies of pixels in microdisplays of a light engine is effectively removed by closing the shutter during pixel transition times. In addition to suppressing the comet tail effect, the light shutter may also be used to level light intensity (or brightness) of an input light source that supplies a light engine, and may be used to adjust the input light intensity to more effectively utilize a full modulation range of modulating devices in the light engine.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The present invention relates to video projection devices, and more particularly to microdisplay based projection devices. In invention is yet more particularly related to the reduction of blur in fast moving objects in video projectors based on Liquid Crystal On Silicon (LCOS) and other microdisplays that have latencies in pixel transition times.

2. Discussion of Background

The components of a video projector 100 (a projection display) are explained by example of a light engine with reference to FIG. 1. As shown, white light 110 is generated by a light source 105. The light is collected, homogenized, polarized, and formed into the proper shape and otherwise processed by optics (not all shown for clarity). The light then enters a prism assembly 150 where it is broken into red, green and blue polarized light beams. A set of microdisplays 152A, 152B, and 152C are provided and positioned to correspond to each of the polarized light beams (the prism assembly 150 with the attached microdisplays is called a kernel). The beams then follow different paths within the prism assembly 150 such that each beam is directed to a specific reflective microdisplay. The microdisplay that interacts with (reflects) the green beam modulates the green content of a full color video image. Similarly, the red and blue contents of the full color image are modulated by corresponding “red” and “blue” microdisplays. The prism assembly 150 then recombines the modulated beams into a modulated white light beam 160 that contains the full color video image. The resultant modulated white light beam 160 then exits the prism assembly 150 and enters a projection lens 165. Finally, the image-containing beam (white light beam 160 has been modulated and now contains the full color image) is projected onto a screen 170.

The kernel is constructed, for example, from a set of beam splitters. The example kernel in FIG. 1 uses a set of 4 polarizing beam splitters. Depending on the design of the kernel, other optical components (e.g., mainly optical elements such as polarizers, waveplates, ColorSelects, filters, dichroics, optical blanks, etc.) may be disposed at various locations within the kernel. In the example kernel of FIG. 1, certain optical elements are disposed, for example, between adjacent faces of the beamsplitters.

One goal in video technology is to produce imagery that is as free of visual artifacts as possible. However, certain types of displays have issues with image quality and particularly the appearance of rapidly moving objects.

When real objects move rapidly in a real environment, they maintain their shape and edge definition. In order to make a video image appear realistic it is desirable that rapidly moving video objects do likewise when moving, in this case, within a video image.

### SUMMARY OF THE INVENTION

The present inventors have realized the need to compensate for latencies in the activation and shutdown of pixels, particularly those transitioning from bright to dark states or vice versa, in modern microdisplay devices. Roughly described, the present invention is a shutter configured to black out projection of a “comet tail” effect. In one embodiment, the present invention provides a light shutter comprising, a polarizing element configured to pass light of a first polarization and block light passage of a second polarization, and a variable retarder in optical series with the polarizing elements configured to be adjustable between a first retardation value and a second retardation value.

In another embodiment, the present invention is incorporated in an image projector comprising, a kernel comprising at least one modulator configured to modulate a light beam with an image data, and a light shutter configured remove portions of frames in the modulated light having artifacts caused by at least one of turn on and turn off latencies in at least one modulator.

The present invention includes a method comprising the steps of preparing a signal based on information comprising transition times of an imaging device, and controlling a light shutter with the signal. The light shutter is, for example, positioned in a light path of an image projection device. The light shutter comprises, for example, a variable retarder in optical series with a reflective linear polarizer, and the light shutter is disposed in polarized light path. In one embodiment, the signal comprises an open/close signal configured to close the light shutter during transition times of pixels of the imaging device. In another embodiment the signal include open, close, and partially open or close command signals. The step of preparing a signal comprises, for example, preparing a signal based on transition times of pixels of the imaging device and motion in a video image, closing the light shutter during transition times of pixels having motion in the video image. The light shutter is, for example, disposed in a light path of an at least 3 channel Liquid Crystal on Silicon (LCOS) projection device.

Portions of both the device and method may be conveniently implemented in programming on a general purpose computer, or networked computers, and the results may be displayed on an output device connected to any of the general purpose, networked computers, or transmitted to a remote device for output or display. In addition, any components of the present invention represented in a computer program, data sequences, and/or control signals may be embodied as an electronic signal broadcast (or transmitted) at any frequency in any medium including, but not limited to, wireless broadcasts, and transmissions over copper wire(s), fiber optic cable(s), and co-ax cable(s), etc.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a drawing of the components of a video projector;

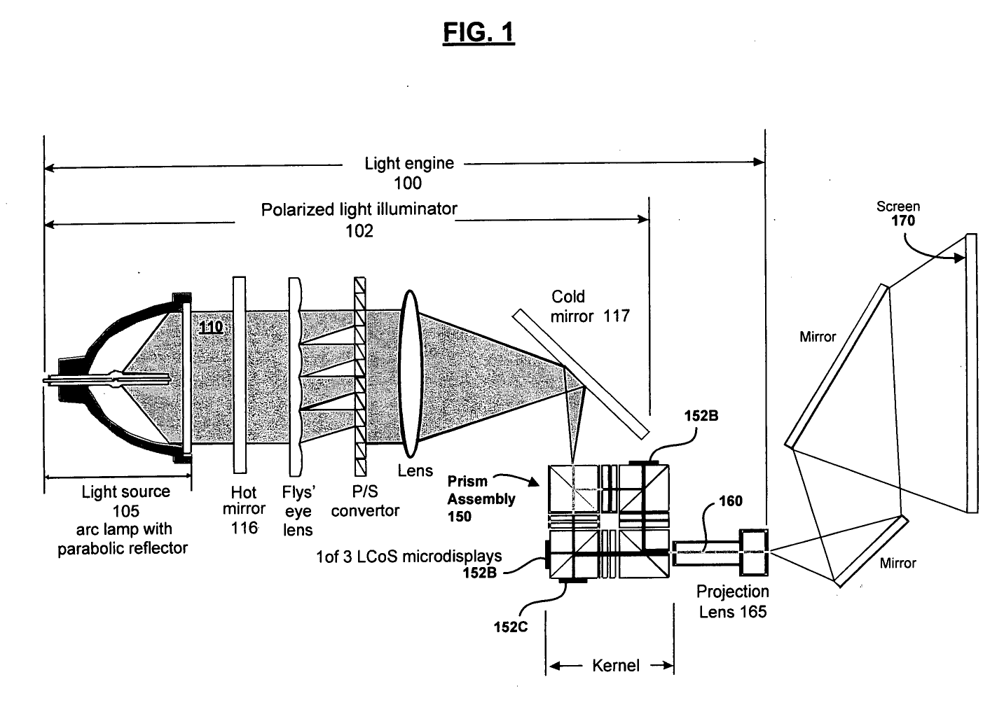

FIG. 2 is a graph illustrating a voltage waveform applied to a liquid crystal pixel and an optical response of the pixel;

FIG. 3 is an illustration of a stationary dark pixel and a moving dark pixel on a background of bright pixels;

FIG. 4 illustrates a generic LCOS based light engine based on a quad-style prism assembly and kernel having a light shutter according to an embodiment of the present invention;

FIG. 5 is a set of graphs illustrating a response of a kernel with a shutter according to an embodiment of the present invention; and

FIG. 6 is a drawing of a light engine having lamp brightness adjustments for both flicker control and contrast ratio improvements according to an embodiment of the present invention.

### DESCRIPTION OF THE PREFERRED EMBODIMENTS

The present invention is based on the inventor's observations, including that when real objects move rapidly in a real environment, they maintain their shape and edge definition. In order to make a video image appear realistic it is desirable that rapidly moving video objects do likewise when moving, in this case, within a video image. As a practical matter, it is found that edge definition can be difficult to fully accomplish in liquid crystal based video projectors.

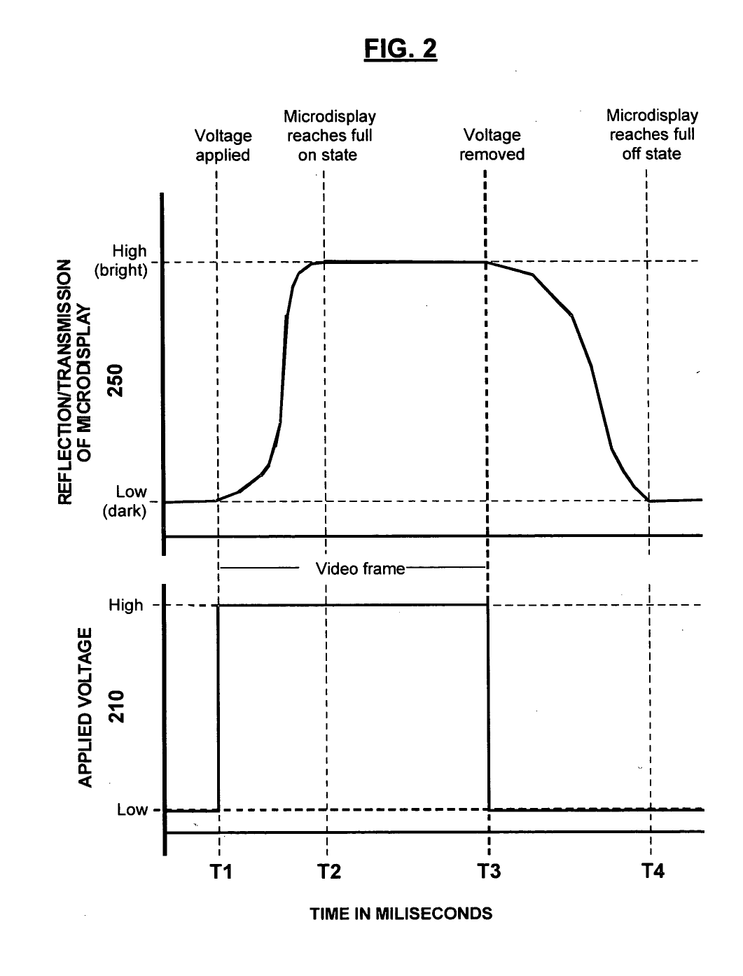

Referring again to the drawings, wherein like reference numerals designate identical or corresponding parts, and more particularly to FIG. 2 thereof, there is illustrated a set of graphics illustrating a voltage waveform applied to a liquid crystal pixel and an optical response of the pixel.

The reason edge definition is difficult to produce is explained with reference to FIG. 2.

The lower portion of FIG. 2 illustrates a voltage waveform applied to a representative liquid crystal pixel. The applied waveform switches the pixel, for example, from its' full dark state to its' full bright state, holds it there for one video frame and then switches the pixel back to its' full dark state. The top portion of FIG. 2 illustrates the general form of the optical response of the pixel. As shown, there is a time interval between the application of the voltage (time T1) at the start of the video frame and the pixel achieving its' full bright state (time T2). Similarly, at the end of the video frame, there is a time interval between removal of the applied voltage (time T3) and the pixel attaining its' full dark state (time T4).

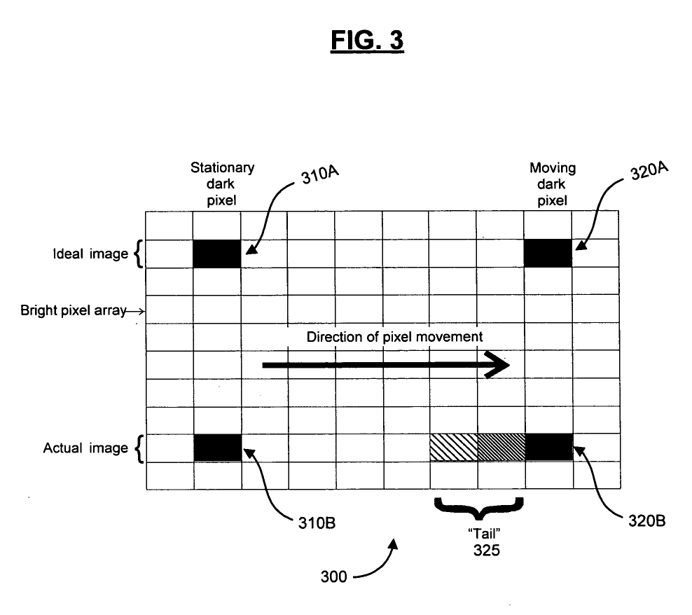

The fact that the pixel utilizes a portion of the video frame to transition between its' full dark and bright states introduces a visual artifact. This is illustrated and further explained with reference to FIG. 3. FIG. 3 illustrates an array of bright pixels 300. Within the array 300 a video object (a single dark pixel) is shown in a stationary position 310A and 310B rapidly moving 320A and 320B from left to right in both ideal 310A, 320A and ideal 310B and realistic 320B situations. Ideally, the stationary and moving pixel would appear as illustrated in the top portion of FIG. 3: black pixel 310A and 320A surrounded by fully bright pixels. In reality, the moving video object appears as illustrated in the bottom portion of FIG. 3 320B and 325. Note that the several pixels 325 adjacent and to the left of the black video object 320B are not fully bright. Rather, they are dark with the degree of blackness decreasing with distance from the moving video object (as illustrated with decreasing hatchmarks). This effect is attributable to the fact that, after the video object moves (e.g., to the right in this example, the voltage is switched to return the now adjacent pixel back to the fully bright state. Because of the transition time, this does not happen immediately and the adjacent pixel does not immediately return to the fully bright state. In fact, even the entire video frame may not be enough time for the adjacent pixel to completely return to its' full bright state. In this case, more than one pixel in the path behind the moving video object will not have returned to its' fully bright state. Pixels furthest from the moving video object would be closest to full bright since they would have had more time to complete the transition. These partially dark pixels constitute what can be described as a comet like tail that follows directly behind the moving video object. The faster the movement of the video object, the longer the tail. The visual impression of the tail is that the video object has become blurry.

The types of liquid crystal based microdisplays that potentially exhibit the comet tail blur effect include High Temperature PolySilicon and Liquid Crystal on Silicon. The present inventor has realized the above and needs to reduce the visibility of the comet tail blur in such displays.

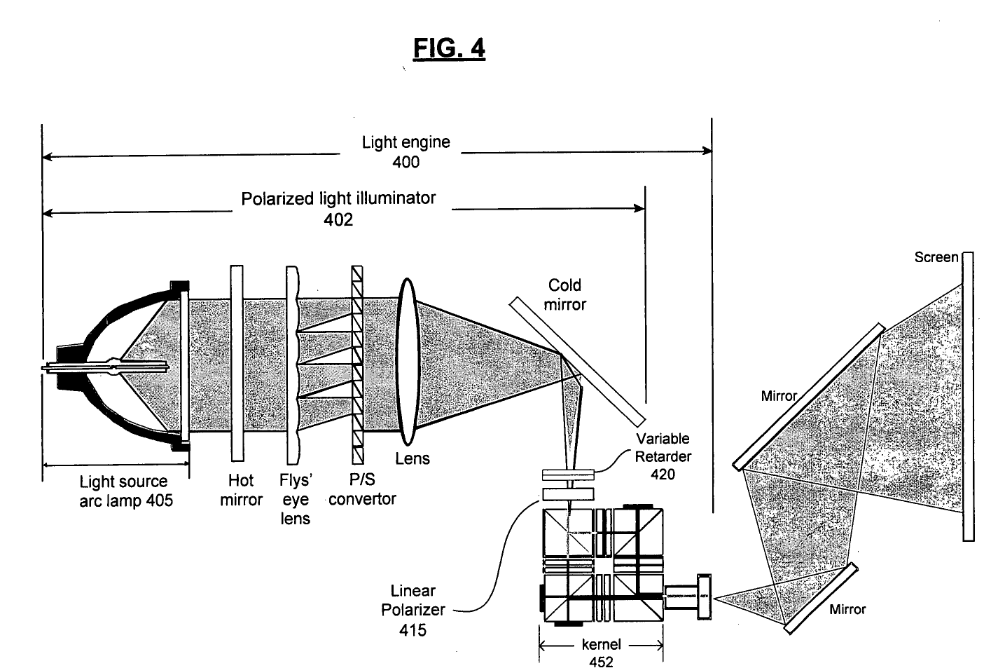

In one embodiment, the present invention is the inclusion of a fast shutter in optical series with a kernel in a projection system. FIG. 4 illustrates a generic LCoS based light engine based on a quad-style prism assembly and kernel having a light shutter according to an embodiment of the present invention. Note that the light output by the illuminator 402 is polarized (e.g., S polarized). Also note that there is linear polarizer 415 positioned at the input to the kernel 452. The transmission axis of the linear polarizer 415 is parallel to the linear polarization output by the illuminator 402. Although not strictly required, this (typically reflective) linear polarizer is often included in the design of the light engine. Its purpose is to improve the extinction ratio of the light input to the kernel. If the linear polarizer is part of the light engine design then there will be little light loss associated with implementing the disclosed means. If the light engine design does not include a linear polarizer at this position, it must be added to implement the disclosed invention. Doing so will introduce a small insertion loss.

A variable retarder 420 is positioned at the input to the kernel 452 just optically upstream of the linear polarizer. The variable retarder should be able to switch at least ½ lambda retardation. The axis of the retarder is oriented 45° to the axes of linearly polarization of both the light output by the illuminator and that of the linear polarizer.

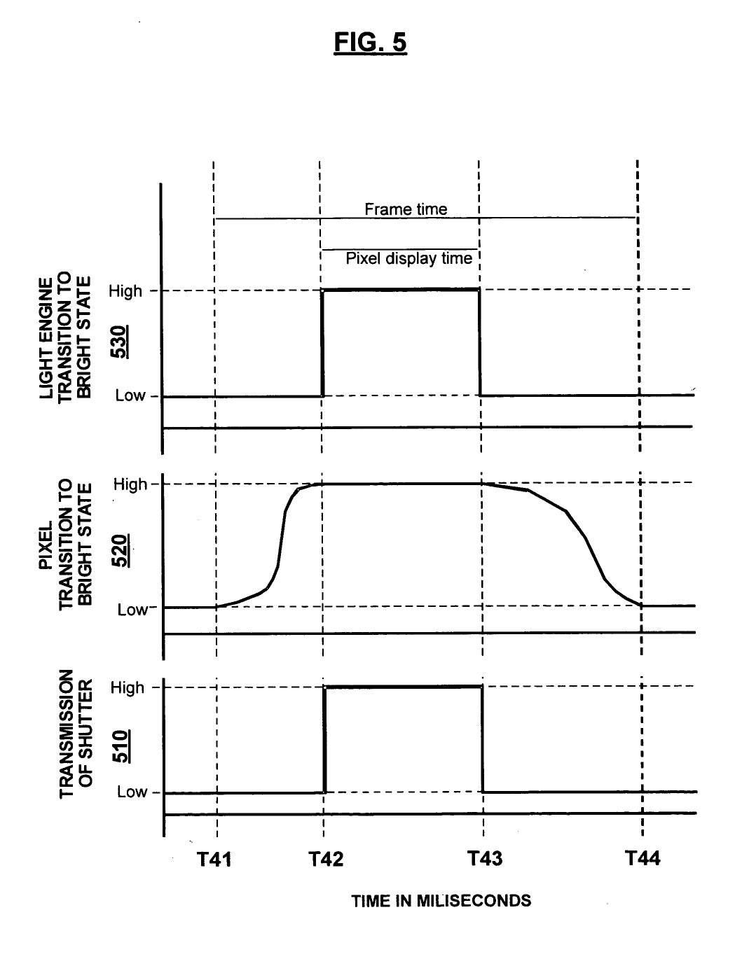

In this application it is desirable for the retarder to switch between 0 and ½ lambda as rapidly as possible. The reason is illustrated and explained with reference to FIG. 5, which is a set of graphs illustrating a response of a kernel with a shutter according to an embodiment of the present invention. Graph 510 figure illustrates the desired switching response of the shutter. The middle of the figure is graph 520 which is similar to the graph previously presented in the top of FIG. 2. Graph 520 illustrates the characteristic response of the pixel.

Since the shutter is in optical series with the pixels the overall transmission of the light engine is equal to the product of their individual transmissions. This is illustrated in the top of FIG. 5 in graph 530. As shown, the timing of the shutter (graph 510) has been chosen such that the transmission of the light engine during those portions of the video frame during which the pixel is in transition have been blacked out (e.g., T41-T42 and T43-T44). In this way the comet tail is suppressed. If no other adjustments are made, the “price” of suppression is that some light is lost and that the brightness of the image is slightly reduced. Blackening a portion of each frame will not be visible to the viewer. The reason is that the typical minimum video frame rate is 120 Hz and this is faster than the human vision system can discriminate.

The present invention includes a shutter that implements multiple image compensating and/or enhancement techniques. For example a shutter may be effectively programmed to adjust light intensity of an image to maximize the effective range of brightness modulation of modulating microdisplays, and/or removing/suppressing the comet tail effect, and/or compensating for light source flicker by increasing/decreasing brightness of input light according to corresponding decreases/increases in brightness of the light source. All of the above performed by, for example, a single shutter configured according to the present invention.

The variable retarder is, for example, a type of liquid crystal shutter of which there are many possible and acceptable configurations. In one embodiment, the retarder utilizes a ferroelectric liquid crystal. The reason is that this liquid crystal mode has a fast and symmetrical switching time. An alternative is a liquid crystal shutter based on the either the 0° or n type surface mode effect.

It should be noted that the linear polarizer and the variable retarder can be separate components included in the light engine. Other possibilities include that these components be combined and/or made part of the kernel.

The shutter can be located at other points in the optical system. Another logical position would be at the output of the kernel. In this case either a green/magenta or a magenta/green ColorSelect wavelength selective retarder is required between the output prism face and the variable retarder. Its' function is to rotate the axes of linear polarization of the red, green and blue output light all into the same (P or S) plane. This polarization input allows the described shutter to function properly.

The light modulation function described for the “analog” surface mode variation of the shutter discussed in this disclosure can be combined with the shuttering function described in previous patent applications. Specifically, in the application entitled “Method and Apparatus to Minimize Lamp Flicker and Increase Contrast Ratio in Projection Devices” by Berman and assigned attorney file number 356508.05300 and in the application entitled “Method and Apparatus for Adjusting Light Intensity” by Berman and assigned attorney file number 356508.04400.

We note that it is also possible to combine the modulation function in conjunction with a “digital” ferroelectric shutter. In this case, producing the intermediate shades of gray needed for flicker suppression and/or the auto iris function requires that the ferro shutter be dithered.

An alternative to the liquid crystal electro-optical shutter discussed in this disclosure, it is possible to use a mechanical shutter for the same purpose. As before, the (mechanical) shutter can be located at any one of several positions in the optical path. In this case the associated components, such as the reflective polarizer and/or green/magenta or magenta/green ColorSelect filter, are not required.

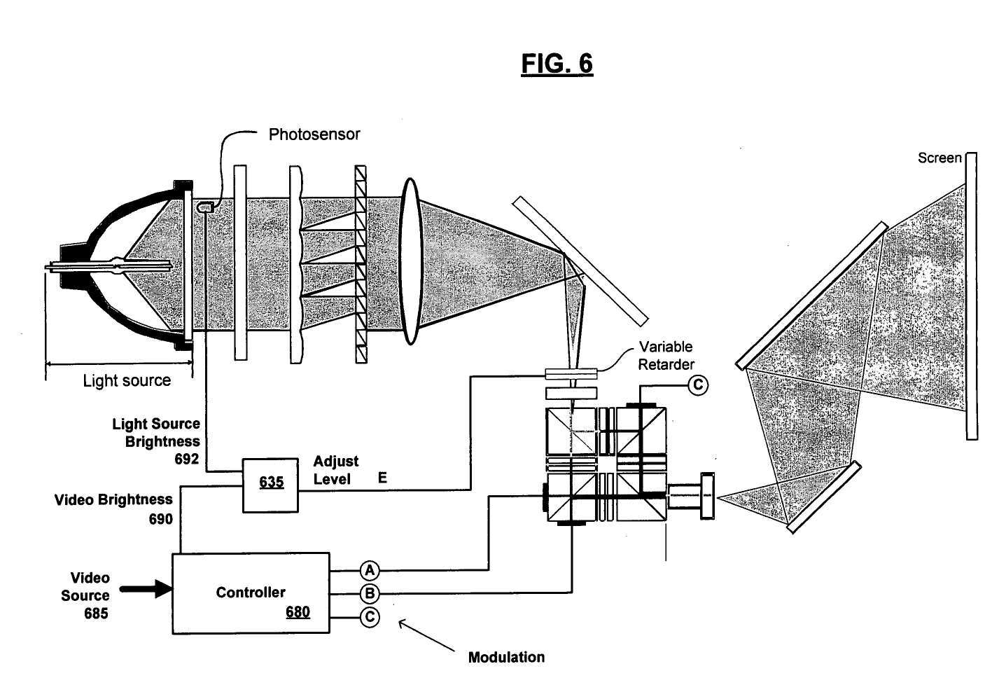

FIG. 6 is a drawing of a light engine having lamp brightness adjustments for both flicker control and contrast ratio improvements according to an embodiment of the present invention. A controller 680 receives a video input signal, or video source 685. The Controller 680, for example, prepares separate content signals for each microdisplay of a kernel design (e.g., Red content, Green content, and Blue content). Each content signal is sent to a respective microdisplay positioned in a color light path corresponding to the color of the content signal provided to the microdisplay.

The controller determines, for example, a video brightness of an image to be displayed from a signal of the video source 685. The controller includes, for example, an image brightness circuit that detects a brightness of the image to be displayed from the video source 685. In another embodiment (not shown) a brightness circuit reads modulation signals (e.g. modulation signals A, B or C) to determine the brightness of the image to be displayed. The controller 680 produces, for example, a video brightness signal 690, a light source brightness signal 692, each of which are provided to a combined driver board 635. The combined driver board takes into account both the brightness of the displayed image and the light source brightness and determines an adjustment level (adjust level). The adjustment level is, for example, an amount of energization E to be provided to the variable retarder in order to implement one or more of the above described compensating and/or enhancement techniques. In combination therewith, the amount of modulation is also provided in signals A, B, and C to each of the microdisplays. The totality of the brightness adjustment and modulation signals produces the desired video brightness while implementing any combination of the above described compensating and/or enhancement techniques.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing reflective linear polarizer or Liquid Crystal (LC) variable retarder, any equivalent device or other device having an equivalent function or capability, whether or not listed herein, may be substituted therewith. Furthermore, the inventors recognize that newly developed technologies not now known may also be substituted for the described parts and still not depart from the scope of the present invention. All other described items, including, but not limited to kernel configurations, light beams, modulators, controllers, driver boards, signals, retarders, polarizers, etc should also be considered in light of any and all available equivalents.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CDRW+/−, micro-drive, and magneto-optical disks, ROMs, RAMs, EPROMs, EEPROMs, DRAMs, VRAMs, flash memory devices (including flash cards, memory sticks), magnetic or optical cards, MEMS, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, detecting brightness in a video image, preparing signals for any of brightness, motion, adjusting modulation levels, and adjusting brightness and/or gray scale modulations according to the processes of the present invention.

The present invention may suitably comprise, consist of, or consist essentially of, any of element (the various parts or features of the invention) and their equivalents as described herein. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

What is claimed and desired to be secured by Letters Patent of the United States is:

1. An image projector, comprising:
a kernel comprising at least one modulator configured to modulate a light beam with an image data; and
a light shutter configured to remove portions of frames in the modulated light having artifacts caused by at least one of turn on and turn off latencies in at least one modulator.

2. The image projector according to claim 1, wherein the artifacts comprise a motion induced “comet tail” effect.

3. The image projector according to claim 1, wherein the at least one modulator comprises a set of Liquid Crystal on Silicon (LCOS) reflective microdisplays and the artifacts comprise LCOS induced “comet tails.”

4. The image projector according to claim 1, wherein the kernel comprises a quad style, at least 3 channel, Liquid Crystal on Silicon reflective miscrodisplay based kernel.

5. The image projector according to claim 1, wherein the light shutter comprises a mechanical light shutter placed in a light path of the kernel.

6. The image projector according to claim 1, wherein the light shutter comprises a variable retarder in optical series with a reflective polarizer.

7. The image projector according to claim 6, wherein the variable retarder comprises a Liquid Crystal (LC) variable retarder.

8. The image projector according to claim 1, further comprising a control device configured to analyze motion in a video image to be modulated into the light beam and produce a shutter signal that closes the light shutter during transition times of the at least one modulator.

9. The image projector according to claim 1, wherein the at least one modulator of the kernel comprises a set of at least 3 reflective Liquid Crystal on Silicon (LCOS) microdisplays.

10. The image projector according to claim 9, wherein the projector comprises a light engine installed in a LCOS based High Definition (HD) Rear Projection Television (RPTV).

11. A light shutter comprising:
a polarizing element configured to pass light of a first polarization and block light passage of a second polarization;
a variable retarder in optical series with the polarizing elements configured to be adjustable between a first retardation value and a second retardation value.

12. The light shutter according to claim 11, wherein the polarizing element comprises a reflective linear polarizer.

13. The light shutter according to claim 11, wherein the variable retarder comprises a Liquid Crystal (LC) variable retarder.

14. The light shutter according to claim 13, wherein the LC variable retarder is switchable between 0 and ½λ retardation of light.

15. The light shutter according to claim 11, wherein:
the polarizing element comprises a reflective linear polarizer;
the variable retarder comprises a Liquid Crystal (LC) variable retarder switchable to varying degrees between approximately 0 and ½λ retardation of light; and
the light shutter is installed in a polarized light beam input to an image modulator.

16. The light shutter according to claim 15, further comprising a control unit configured to analyze at least one of brightness of the light beam input, brightness of an image to be modulated into the light beam input, and motion of the image to produce a shutter signal that controls the amount of retardation in the LC variable retarder to at least one of remove a motion induced comet tail effect, compensate for variations of input light brightness, and adjust input light intensity.

17. the light shutter according to claim 11, further comprising a wavelength specific retarder in optical series with and before the shutter in an output beam of an image modulator.

18. The light shutter according to claim 16, wherein the image modulator is a quad-style Liquid Crystal on Silicon (LCOS) kernel.

19. A method, comprising the steps of:
preparing a signal based on information comprising transition times of an imaging device; and
controlling a light shutter with the signal.

20. The method according to claim 19, wherein the light shutter is positioned in a light path of an image projection device.

21. The method according to claim 19, wherein the light shutter comprises a variable retarder.

22. The method according to claim 19 wherein:
the light shutter comprises a variable retarder in optical series with a reflective linear polarizer; and
the light shutter is disposed in polarized light path.

23. The method according to claim 19, wherein the signal comprises an open/close signal configured to close the light shutter during transition times of pixels of the imaging device.

24. The method according to claim 19, wherein the step of preparing a signal comprises preparing a signal based on transition times of pixels of the imaging device and motion in a video image; and
the signal comprises an open/close signal configured to close the light shutter during transition times of pixels having motion in the video image.

25. The method according to claim 24, wherein said motion comprises motion in the video image above a predetermined motion speed threshold.

26. The method according to claim 19, wherein:
said method is embodied in a set of computer instructions stored on a computer readable media; and
said computer instructions, when loaded into a computer, cause the computer to perform the steps of said method.

27. The method according to claim 19, wherein the light shutter is a variable retarder in optical series with a reflective linear polarizer disposed in a light path of an at least 3 channel Liquid Crystal on Silicon (LCOS) projection device.

28. The method according to claim 9, wherein the LCoS projection device comprises a High Definition (HD) Rear Projection Television (RPTV).
